(19) United States
(12) Patent Application Publication
(10) Pub. No.: US 2016/0286792 A1
(43) Pub. Date: Oct. 6, 2016

(54) METHOD AND SYSTEM FOR PEST CONTROL

(71) Applicant: Bradley CARPENTER, Narangba, Queensland (AU)

(72) Inventor: Bradley CARPENTER, Narangba, Queensland (AU)

(21) Appl. No.: 15/038,167

(22) PCT Filed: Nov. 26, 2014
(86) PCT No.: PCT/AU2014/050374

§ 371 Date: May 20, 2016

(30) Foreign Application Priority Data
Nov. 26, 2013 (AU) 2013101549

(51) Int. Cl. A01N 25/08; A01M 1/24; A01M 17/00; A01M 1/20

(52) U.S. Cl. CPC A01N 25/08; A01M 1/20; A01M 1/245; A01M 17/002; A01M 2200/011

(57) ABSTRACT

A method for contacting the soil about a building with one or more insect active agents. The method includes providing an insect active agent, providing a soil permeability modifying agent, contacting the soil with the soil permeability modifying agent to provide a modified soil, and contacting the modified soil with the insect active agent. The soil permeability modifying agent improves the soil permeability to facilitate penetration of the insect active agent into the soil.

### FIELD OF THE INVENTION

The present invention is directed to the prevention and treatment of insect infestation of buildings. In particular, the invention is directed to apparatus and methods for the deposition of insecticides and other active compounds about a building.

### BACKGROUND TO THE INVENTION

Infestation of buildings with insects is a significant consideration for building construction and maintenance. Termite infestation is a particular problem, with these insects being well known to cause significant property damage in many areas across the globe.

Termites are relentless in their search for food and regularly infest all manner of structures that utilize timber in construction. Homes, high rise concrete apartments, office blocks, bridges, wharfs, and other seemingly inaccessible areas. In extreme circumstances, entire housing developments have been demolished as a result of termite infestation.

Termites enter buildings from underground with their presence being usually discovered only after damage becomes obvious. Modern house construction provides an ideal combination of obscure access and significant food source. Termites generally attack from the inside out and it is common for significant activity and consequent damage to be concealed behind walls that reveal no external evidence. By this stage, repair costs can be significant.

Termite risk is so high that all new buildings and ground level extensions in Australia (and many other countries) are required to incorporate a physical barrier in construction. Products such as Termimesh™ and Kordon™ are often used. Despite the use of physical barriers many new homes have termite activity before occupancy. A further problem is that physical barriers must be incorporated into the building during construction, retrofitting is not feasible.

The most common option for the treatment of existing buildings is to use liquid pesticide. Australian standard 3660.2-2000 defines procedures for full perimeter excavated trenching as the only means of achieving a complete and unbroken treatment zone. While effective, excavated trenching is expensive, and often prohibitively so for home owners.

Lower cost procedures using liquid pesticide are known in the art. Rod injection is by far the most common form of termite protection provided by the pest control industry. The process involves drilling 12 mm holes through the hard concrete abutment surrounding the home (about 150 mmm from the slab edge, at about 200 mmm centres) and injecting liquid pesticide through a rod applicator. The objective is to achieve saturation from each hole to meet with the next to form a continuous, full depth, poison barrier.

Rod injection has been so extensively utilized that it has become the accepted method for termite protection where trench excavation is not an option. Continuity of the pesticide around the building perimeter is critical to efficacy of rod injection. Even small breeches allow foraging termites easy access to the home. In practice, gaps are typically found in the pesticide perimeter.

Accordingly, Australian Standards classify rod injection as a “partial” or “incomplete” barrier treatment.

It is an aspect of the present invention to overcome and alleviate a problem of the prior art by providing an economical and effective alternative to prior art methods for the delivery of pesticides about a perimeter of a building.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each provisional claim of this application.

### SUMMARY OF THE INVENTION

In a first aspect, but not necessarily the broadest aspect, the present invention provides a method for contacting the soil about a building with one or more insect active agents, the method comprising the steps of
providing an insect active agent,
providing a soil permeability modifying agent,
contacting the soil with the soil permeability modifying agent to provide a modified soil, and
contacting the modified soil with the insect active agent,

wherein the soil permeability modifying agent improves the soil permeability to facilitate penetration of the insect active agent into the soil.

In one embodiment, the soil is contacted with the soil permeability modifying agent before contacting the soil with the insect active agent.

In one embodiment, the soil permeability modifying agent increases permeability of the soil.

In one embodiment, the soil permeability modifying agent is capable of increasing the permeability of clay soil and/or a sodic soil.

In one embodiment, the soil permeability modifying agent acts by an electrolyte effect and/or by an ion exchange effect and/or by a wetting effect and/or a soil pore stabilizing effect and/or by a detergent effect, and/or by a penetrant effect, and/or by a flocculent effect, and/or by an emulsifying effect, and/or by a soil stabilizing effect.

In one embodiment, the soil permeability modifying agent comprises gypsum and/or lime.

In one embodiment, the insect active agent is active against a termite species.

In one embodiment, where the building has an abutting structure, the insect active agent and soil permeability modifying agent are contacted with the soil via a channel disposed between the external wall of the building and the abutting structure,

In one embodiment, the channel is an abutment gap included in the construction of the building and/or abutting structure.

In one embodiment, where the building has an abutting structure, the insect active agent and soil permeability modifying agent are contacted with the soil via a plurality of bore holes disposed in the abutting structure.

In one embodiment, the plurality of bore holes are disposed proximal to the external wall of the building.

In one embodiment, the existing bore holes are bore holes that were created primarily or exclusively for the rod injection of an insect active agent into the soil beneath the abutting structure.

In one embodiment, a substantially continuous zone of insect active agent is provided about the perimeter of the building.

In one embodiment, the method does not require excavation of the soil about the building.

In a further aspect the present invention provides a system for contacting the soil about a building with one or more active agents, the system comprising:
fluid delivery means configured to dispense an insect active agent and a soil permeability modifying agent to a zone of soil,
an insect active agent, and
a soil permeability modifying agent.

### BRIEF DESCRIPTION OF THE DRAWINGS

FIG. 1 shows diagrammatically (in cross-sectional view) a preferred embodiment of the invention as installed about a building having an abutting structure, and where a gap joint exists between the external wall of the building and the abutting structure.

FIG. 2 shows diagrammatically (in cross-sectional view) a preferred embodiment of the invention as installed about a building having an abutting structure, and where a series of bore holes exists in the abutting structure.

FIG. 3 shows diagrammatically (in cross-sectional view) a preferred embodiment of the invention as installed about a building having no abutting structure.

### DETAILED DESCRIPTION OF THE INVENTION

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

In a first aspect, the present invention provides a method for contacting the soil about a building with one or more active agents, the method comprising the steps of providing an active agent delivery means, installing the delivery means about a part or the entirety of the building perimeter, the delivery means configured to dispense the insect active agent in a substantially continuous zone of the soil about the building.

Applicant proposes that initial and repeat applications of active agents (such as insecticidal compositions for the treatment or prevention of termite infestation) is facilitated by the installation of a delivery means (such as a perforated pipe) around the perimeter of a building. The installed delivery means allows for the controlled application of active agent to the soil about the building thereby creating a continuous zone of agent with the soil thereby preventing (or at least ameliorating) the ability for termites to enter the building and cause damage.

The present methods are an improvement on, or an alternative to, prior art methods of applying insecticides and the like about a building. For example, rod injection of insecticides often fails to provide a continuous zone of protection given that injections are made at large intervals about the perimeter. By contrast the present methods may provide for the delivery of insecticides at relatively smaller intervals (and optionally at slower delivery rates, and over longer periods of time such as greater than about 1, 2, 3, 4, 5, 6, 12, 24, 48, 72 hours, or 1 week) to provide a greater opportunity for the insecticide to penetrate into the soil, there providing for a substantially continuous zone and an optionally deeper and/or broader zone of treated soil as compared with the prior art methods. Penetration may be further assisted by the use of agents capable of enhancing the permeability of soil, with further disclosure of those embodiments being provided infra.

Prior art methods may not provide sufficient time for active agents to penetrate into the soil. By contrast, the present methods allow for the slow percolation of active agent into the soil. Indeed, in some embodiments of the method where the soil is highly impacted or otherwise of reduced permeability, the delivery means may continuously deliver active agent to the soil at a very slow rate. Resistance to penetration by the soil may act as a means for controlling delivery rate.

Moreover, rod injection is very labour intensive and requires specialist equipment to inject insecticide (often under significant pressure) into the soil about a building. Where reapplication is required, the contractor must return to perform the specialist injection procedure. By contrast, the ongoing presence of the installed delivery means allows for many reapplications of insecticide (possibly over decades) at minimal cost. This ensures ongoing and effective exclusion of termites from a home at minimal cost. Indeed, a reapplication is well within the ability of a home owner who may elect to attend to reapplications himself or herself. All that is required is for the home owner to supply active agent to the delivery means, and allow the agent to penetrate the soil.

Delivery means useful in the context of the present invention, may be any means known to the skilled artisan capable of carrying a liquid through the channel (horizontally and/or vertically) such that the liquid enters the channel and contacts soil under the abutment and/or building.

As one example, the delivery means may be a simple conduit (such as a pipe) having perforations along its length. The perforations may be sized or otherwise configured to release liquid at a predetermined rate into the channel. In such embodiments, it will typically be desirable to ensure that soil areas toward the end of the conduit (i.e. distal to the supply of the agent) are dosed with substantially the same volume of agent as areas proximal to the start of the conduit (i.e. proximal to the supply of liquid).

In circumstances where rates of agent release are not uniform along the length of the conduit, the conduit may comprise two discrete sub-conduits: the first running clockwise around the building, with the second running in a counter-clockwise direction. This embodiment provides a compensation for any lower release of liquid at distal parts of the first sub conduit, by the juxtaposition of the second sub-conduit which releases liquid at a higher rate.

Alternatively, the conduit may be fitted with various valves, flow regulators, baffles and the like to provide for more even delivery along the conduit. Given the benefit of the present specification the skilled person is enabled to provide other means for generating more even delivery of the agent.

In some embodiments the agent is under pressure within the conduit, and so sufficient amounts of agent are released from distal portions of the conduit.

In other embodiments, (and where the agent is supplied by a reservoir) multiple reservoirs may be disposed around the circuit to even out delivery of the agent to multiple separate linear sections.

As further alternative the conduit may be an “oozing hose”, of the type disclosed in United States patent publication 20070278330 A3, or similar.

It will be understood that it is not essential for the delivery of agent to be entirely uniform, with embodiments demonstrated less-than-uniform delivery being included in the present invention. Generally, an efficacious delivery is provided for where all soil areas receive a minimum dose of active agent. This may result in some soil areas receiving a higher than required dosage, leading to some wastage of the agent.

Other delivery means contemplated include an elongate wicking material that may be disposed within the channel. Fluid may be applied at one or more locations along the elongate wicking material. Once the wicking material is saturated, liquid will start dripping onto the underlying soil.

The delivery means may comprise a plurality of spray nozzles disposed closely to each other. The nozzles may be fed by a single conduit or multiple conduits.

Prior art rod injection methods ignore the gap joint and typically involves drilling holes through the external abutments. Rod injection methods rely on the rapid pumping of large amounts of insecticide into the soil, and is therefore not suited to exploitation of the gap joint.

Applicant has found that the existing gap joint surrounding many types of buildings (including houses) provides a useful channel for the delivery of an insect active agent about the building. The gap joint may be used to achieve a continuous and unbroken treatment zone around the building boundary thereby providing an improvement in protection against termites and other insects.

The channel may include a flexible sealant disposed therein to exclude water, and sometimes a filler material disposed beneath the sealant. However these are typically removed to facilitate access to the soil beneath. Accordingly, in one embodiment the method comprises the step of removing a filler and/or sealant disposed within the existing channel.

It is preferable (although not essential) for the zone of soil contacted by the active agent to completely encircle the building such that there is no untreated area thereby allowing for entry by termites.

Some buildings are surrounded (or at least partially surrounded) by permanent and semi-permanent structures which may interfere with the application of insecticides about the perimeter. For example concrete paths, patios swimming pool surrounds, drive ways, paving tiles, and the like are impermeable (or at least have a low permeability) to water. Accordingly, these structures can impede or completely prevent the proper application of insecticide solutions to the soil underlying. To overcome this problem, Applicant proposes the exploitation of an existing channel, such as gaps and joints that are often disposed between the external wall of a building and an abutting structure, as a portal to deliver insecticide to the soil. These abutment gaps are typically between several millimetres to ten millimetres or more. Such channels are typically deliberately included in the construction of the building and/or abutting structure, generally to allow for the relative movement between the two structures, or for one or both of the structures to expand without with cracking.

Thus, a perforated pipe (or any other suitable contrivance) may be disposed above, about, or within a channel in a manner allowing for an insecticide solution being carried by the conduit to exit the conduit and enter the channel. Once in the channel, the insecticide solution runs into the underlying soil and penetrates to a depth required to give adequate protection to the property.

In some circumstances, the delivery means may sit on top of the abutting structure and up against the external wall of the building. This often required where the channel is of insufficient width and/or depth to accommodate the delivery means. In these situations, the edge of the abutting structure may be cut to form a shallow channel within which the delivery means is fully accommodated. As will be appreciated, the trench must be in fluid connection with the channel to allow the agent to flow into and contact the underlying soil.

The delivery means may have means for releasing the agent at discrete intervals. Typically, perforations are used. The perforations may allow the agent to drip out under the force of gravity and/or any existing hydrostatic pressure in the delivery means. Alternatively, the perforations may spray agent into the channel, in which case the supply of agent will be pressurised in some manner.

A suitable interval between perforations (or other release means) may be arrived at by a consideration of parameters such as soil permeability, any pressure used in delivering the agent, a physico-chemical property of the agent, a desired maximum or minimum duration for the method and the like. In some embodiments, the interval is selected from the group consisting of an interval at least about 10, 20, 30, 40, 50, 60, 70, 80, 90, 100, 125, 150, 175, 200, 250, 300, 350, 400, 450 and 500 cm. In some embodiments, the interval is equal to or less than an interval typically used for rod injection techniques. Current industry standard requires a maximum hole spacing interval of 20 cm for rod injection techniques.

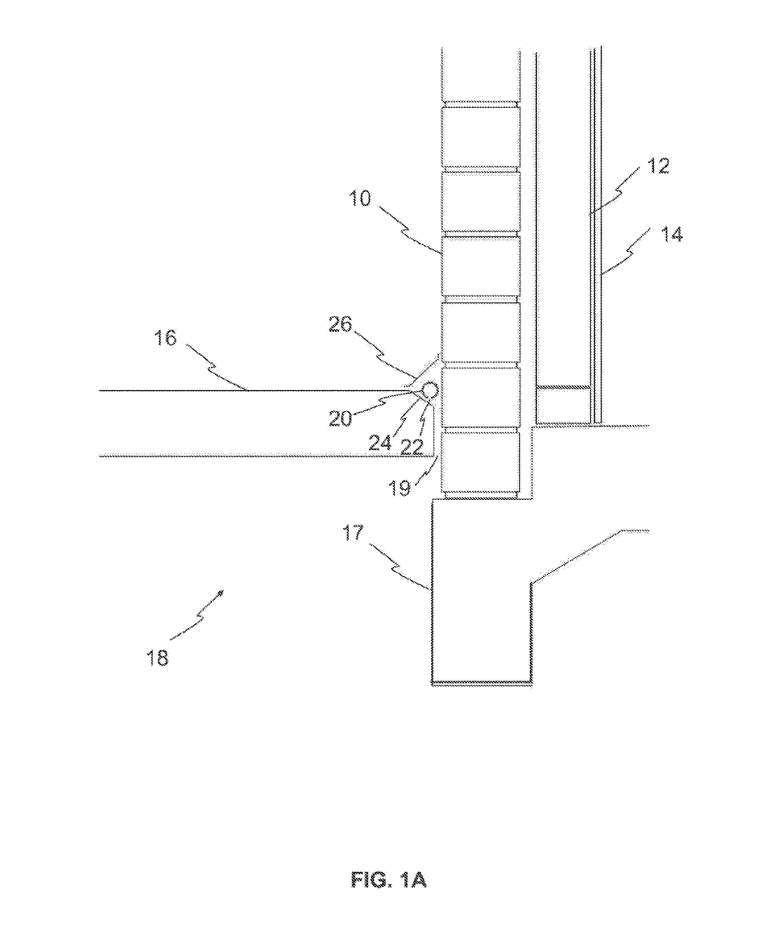

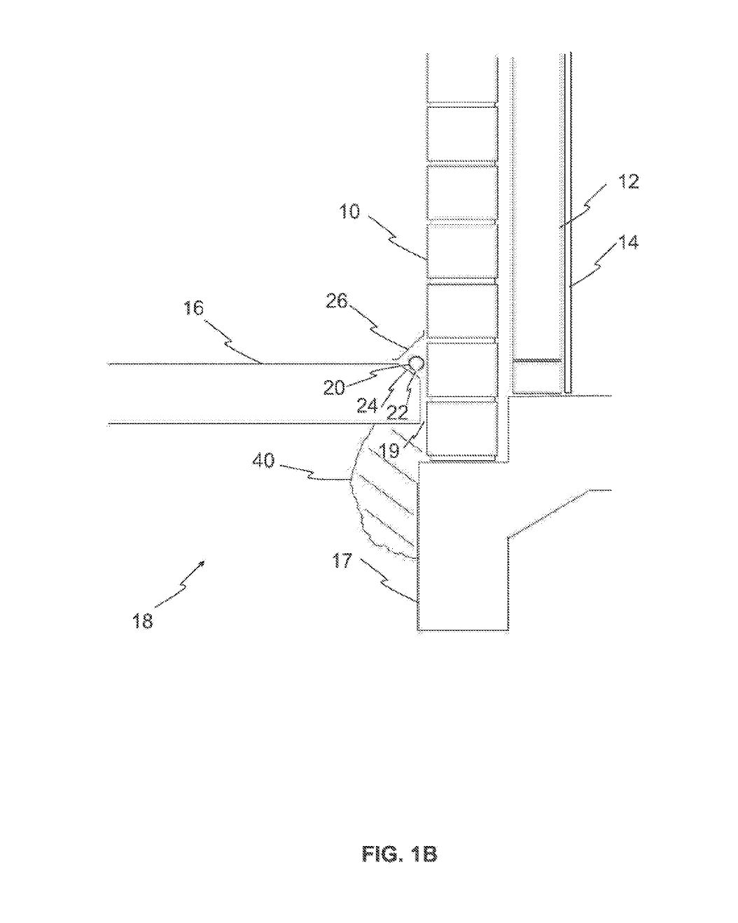

As an alternative to a shallow trench, the edge of the abutting structure may be simply beveled, allowing the delivery means to sit partially below the surface of the abutting structure. An exemplary embodiment is shown at FIG. 1. For aesthetic, safety or functional purposes a trim may be disposed about the delivery means. The trim may act to seal or prevent movement of the delivery means.

Boreholes dedicated for use in the present invention may be drilled (for example about 150 mmm from a structure external wall) rather than using the abutment gap where contraindicated. This alternative approach may be necessary by reason of a physical obstruction or other challenge preventing use of the abutment gap.

Other portals for the delivery of active agent to soil which may be exploited by the present methods are bore holes which have been previously drilled into the abutting structure. Bore holes are often used in the rod injection of termite active agents, with the delivery means of the present methods in some embodiments being configured to use these portals. Thus, in one aspect the present invention provides for the use of existing rod injection bore holes in contacting an active agent to soil about a structure. Rod injection boreholes have been installed in many thousands of properties in Australia, with millions in existence on a global basis. These boreholes are typically handicapped by impermeable soil. Cutting a channel and fitting active agent delivery means to create effective treatment zone about a structure will be a beneficial use of this existing infrastructure. The use of a pre-treatment step to contact a soil with a permeability modifying agent will assist in contacting the soil with the active agent to provide a substantially continuous treated zone around the structure.

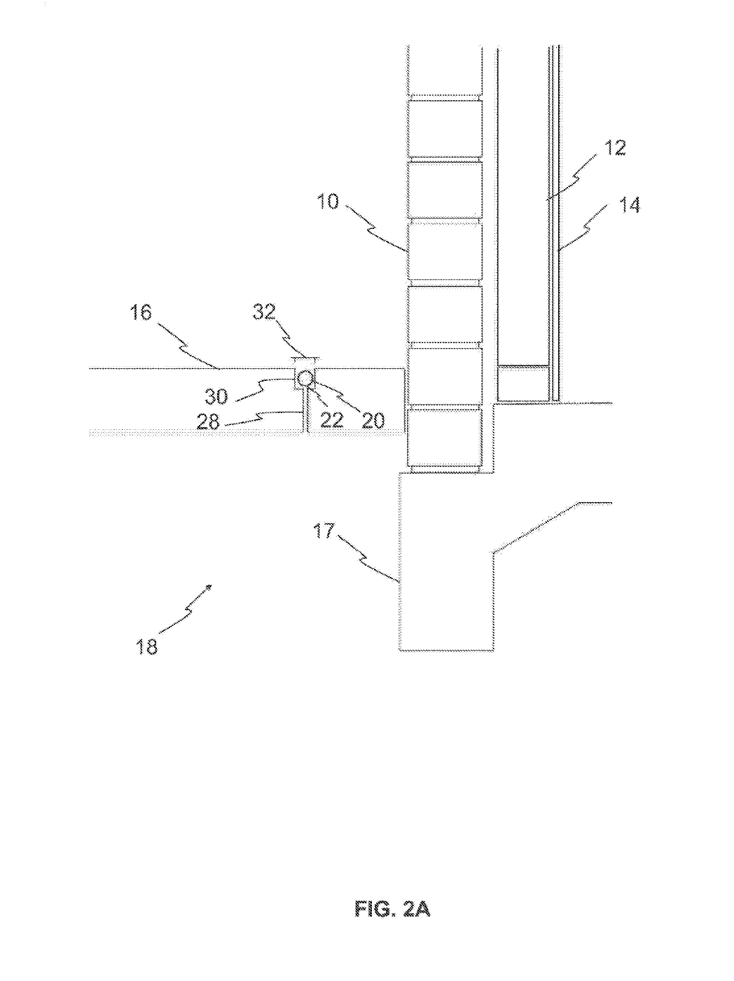

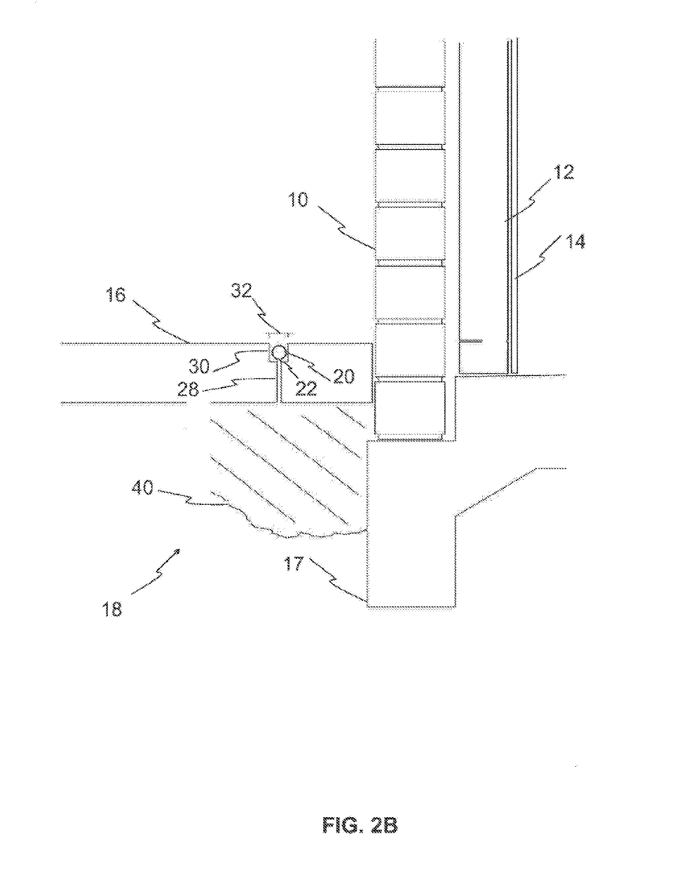

In such embodiments, the delivery means runs from one bore hole to another with the delivery means configured to deliver the active agent into the bore hole. The agent then flows into the underlying soil to form a zone of protection. Given that bore holes are typically disposed some distance from the external wall of the building it may be desirable to cut a shallow trench in the abutting structure to fully accommodate the delivery means. In this way, no part of the delivery means projects above the surface of the abutting structure. Damage to the delivery means is prevented, as are tripping incidents. An exemplary embodiment is shown in FIG. 2, including the use of a trench cover.

The abutting structure may be any substantially liquid impermeable structure disposed above an area of soil, the area of soil being a desirable or necessary area for impregnation with an insect active agent. The abutting structure may be a substantially permanent or semipermanent structure and may be inconvenient and/or expensive to remove and replace.

In one embodiment, the abutting structure was laid after laying the building foundation.

In another embodiment the abutting structure is substantially impermeable to liquid, and is optionally composed substantially of concrete, brick or masonry.

In one embodiment the abutting structure is a concrete slab.

In one embodiment the delivery means is configured to be installed at least for an extended time period, or permanently.

Once the delivery means is installed, a fluid connection may be made with a supply of the active agent. The supply may be in the form of a reservoir in which case the reservoir is typically installed at a point above the ground to facilitate gravity causing the agent to flow into the delivery means. For example the reservoir may be affixed to an external wall of the building with a conduit connecting the reservoir to the delivery means.

Where the method utilises pressure, the reservoir may be connected to a pressurised air source which acts to force agent from the reservoir and into the delivery means (and ultimately into the soil).

The installer (or indeed any other person, such as the building owner) may place the active agent into the reservoir when soil treatment is required.

The active agent of the present methods may be any agent necessary or desirable for the treatment of soil about the building. In a preferred embodiment, the active agent is active against an insect that is liable to cause damage to the building, or to otherwise infest the building by moving across or through soil surrounding the building. In one embodiment the active agent is active against a termite species, and optionally against any of the following species: Mastotermes, Coptotermes, Schedorhinotermes, Nasutitermes, Heterotermes, Microcerotermes.

The active agent may repel or kill a termite species, interfere with the reproduction or growth of a termite species, or otherwise adversely affect the ability of a termite species to travel.

A potentially suitable active agent is Bifenthrin, which is a synthetic pyrethroid pesticide registered for both pre-construction barrier treatments in new buildings and for perimeter barrier treatments around existing buildings. Currently, there exists a choice of three concentrations at which this chemical may be legally applied. These concentrations are 0.1%, 0.05% and 0.25%, Each of these rates provides a different length of protection as follows—at least 10 years, 10 years and 3 years respectively.

Another termrite active agent is Chlorpyrifos, which is an organophosphorus insecticide registered for both pre-construction barrier treatments in new buildings and for perimeter barrier treatments around existing buildings. The concentration of application varies depending on the actual brand used. Generally, chlorpyrifos will provide up to 5 years protection.

Imidacloprid is an insecticide registered for termite barrier treatments to existing buildings only. Imidacloprid is applied at 0.25% and will provide up to 3 years protection is of low to medium toxicity to humans.

Fipronil is an extremely active insecticide belonging to the phenylpyrazole family. It is used to create a barrier around existing buildings only. Termites are attracted to the chemical where they die, partly from the effect of the chemical and partly from infection with fungi and other soil microorganisms.

The present disclosure is directed to methods for controlling termites, however it will be understood that applicability to other insects in contemplated. Given the benefit of the present specification, the skilled person is adequately enabled to select an active agent for use with any other insect species. Such embodiments are included in the ambit of the present invention.

Even where clear access to soil is provided for, in some circumstances it is found that termites are still able to infest a building, even where the soil about the entire perimeter has been dosed with a putatively efficacious dose of insecticide. Applicant proposes that substantial advantage is gained whereby the permeability of soil is improved before, during or after dosing with insecticide. This allows for greater or more even contact of the insecticide with the soil thereby improving the building protection. In one embodiment, the soil is contacted with the soil permeability modifying agent before dosage with the insect active agent. In one embodiment, the soil is contacted with the soil permeability modifying agent during dosage with the insect active agent. In one embodiment, the soil is contacted with the soil permeability modifying agent before and during dosage with the insect active agent. In one embodiment, the soil is contacted with the soil permeability modifying agent after dosage with the insect active agent. In one embodiment, the soil is contacted with the soil permeability modifying agent before and after dosage with the insect active agent. In one embodiment, the soil is contacted with the soil permeability modifying agent during and after dosage with the insect active agent. In one embodiment, the soil is contacted with the soil permeability modifying agent before, during and after dosage with the insect active agent

In one embodiment, the soil permeability modifying agent acts to stabilise soil pores such that upon contact with a solution of insect active agent the porosity (and therefore permeability) is substantially preserved (or at least lost to a lesser extent than would otherwise be expected). Compositions potentially useful in this regard include electrolytes such as sodium salts, potassium salts, calcium salts, magnesium salts, chloride salts, hydrogen phosphate salts, hydrogen carbonate (bicarbonate) salts, reacted hydrated calcium salts, acetate salts, ammonium salts, sulphate salts, nitrate salts and iron salts; any of which may be in combination with a cofactor such as thiamine pyrophosphate, thiamine monophosphate, thiamine mononitrate, riboflavin phosphate, nicotinic acid, folinic acid, pantothenic acid, cyanocobalomin, inositol monophosphate, inositol macinate, and inositol hexophosphate. Further additions to the combination may include anionic surfactants such as alkyl sulphates (exemplary species being ammonium lauryl sulphate, sodium lauryl sulphate and the related alkyl-ether sulphate, and sodium myreth sulphate). Such combinations may further include an elemental micro nutrient zinc salts, ferric salts, ferrous salts, magnesium salts, manganese salts, cupric salts, baron salts, molybdenum salts, and cobalt salts.

The soil permeability modifying agent is or is in combination with a wetting agent, with exemplary species including alkylphenol ethoxylates (APE), nonylphenol ethoxylates (NPE), polyoxyethylene (POE), anionic linear surfactants, yucca or seaweed mixed with APE, EO/PO block copolymers, organosilicones, block copolymer and APG blends, and methyl capped block copolymers.

The soil permeability modifying agent is or is in combination with be a penetrant, with exemplary species including di-octyl sulfosuccinate, polyoxyalkylene polymers such as alkyl amine oxide, the alkyl amine oxide being decyl dimethyl amine oxide, lauryl dimethyl amine oxide, myristyl dimethyl amine oxide, cetyl dimethyl amine oxide, or mixtures thereof. Other compounds that may be used are alkyl ethoxylated quaternary ammonium compounds, a nonionic surfactant being an ethoxylate and salicylic acid.

In other embodiments, the soil permeability modifying agent is or is in combination with a polymer selected from one or more of the group consisting of: synthetic anionic acrylic copolymers, poly(acrylamide-co-acrylic acid), polyelectrolytic polymers, starch or cellulose xanthate, acid-hydrolyzed cellulose microfibrils, chitosan, polyvinyl alcohol, hydrolysed polyethyl acrylates, polymethyl methacrylate, polycaproamide, hydrolyzed polyacrylonitrile (HP AN), isobutylene maleic acid (IBM), polyacrylamide (PAM), polyvinyl alcohol (PVA), sodium polyacrylate (SPA), vinylacetate maleic acid (VAMA) and hydrolyzed starch polyacrylonitrile graft polymers.

In other embodiments, the soil permeability modifying agent is or is in combination with a flocculating agent with exemplary forms including iron sulphate, iron chloride, isinglass, calcium silicate, sodium silicate, gelatin, guar gum, xanthan gum, chitosan, and potassium alginate.

In other embodiments, the soil permeability modifying agent is or is in combination with an emulsifier with exemplary forms including polyethoxylated phenols, guar gum, xanthan gum, and pectin.

In other embodiments, the soil permeability modifying agent is or is in combination with an with a soil stabiliser, exemplary forms including sodium humate, potassium humate, calcium humate, humic acid, fulvic acid, ulmic acid, calcium lignosulphonate, potassium lignosulphonate, magnesium lignosulphonate, sucrose, mannitose, glucose, fructose, corn steep liquor, corn starch, lactose, dextrose, raffinose, fructose phosphate, super sulphonated humate, mannitol, sorbitol, gluconic acid, pyruvic acid, malic acid, and glucaric acid.

In other embodiments, the soil permeability modifying agent is or is in combination with an with a complexing agent, exemplary forms including saccharic acid, tannic acid, succinic acid, citric acid, calcium lignosulphonate, potassium lignosulfonate, ethylenediamine-N,N′-diaectic acid (EDDA), ethylenediamine-N,N,N′,N′-tetraaectic acid (EDTA), trans-\,2-diaminecyclohexane-N,N,N′,N′-tetraacetatic acid (CDTA), and N-(2-hydroxyethyl)ethylenediaminetriaectic acid (HEDTA).

Given the benefit of the present disclosure, the skilled person is capable of indentifying and trialling of agents potentially useful in increasing the permeability of soil.

In one embodiment the agent is capable of improving the permeability of a sodic clay soil. Sodic soils are said to be ‘dispersive’ meaning they tend to lose their structure when wet. More precisely, sodic soils are dominated by sodium or magnesium on their cation exchange sites. When wet, these cations occupy much of the space around cation exchange sites preventing clay particles from getting close enough to bond together.

By contrast, calcium is a much more compact cation when wet. If calcium dominates the cation exchange sites of clay particles the soil will be much more stable in the presence of water, wet clay particles are able to stay close together enabling flocculation and protecting the soil's aggregation.

A soil may be considered ‘sodic’ if the exchangeable sodium percentage (ESP) is greater than 6%.

A test for sodicity or dispersion may be effected by placing several 3-5 mmm crumbs of soil in a shallow vessel containing rain water. If a cloudy halo develops around the soil crumb in 2 hours the soil is dispersive or sodic.

The soil permeability modifying agent may be capable of exchanging an anionic charge or a cationic charge with the soil, and may include a calcium salt and/or a sulphate salt.

Prior art clay breakers such as gypsum (calcium sulphate dihydrate: CaSO₄.2H₂O. have applicability to the present methods given their ability to improve porosity of soil. There are two ways in which gypsum works:

1: Salt (or electrolyte) effect. As mentioned supra, sodic soils disperse in the presence of rain water. If the water is salty this may prevent the soil from dispersing. Gypsum is a salt and is moderately soluble in water.

2: Calcium effect. As the gypsum dissolves and leaches through the soil, calcium ions replace some of the sodium (or magnesium) ions on the clay particles' cation exchange sites. Once calcium dominates the cation exchange sites the clay particles no longer disperse when wet.

Lime (calcium carbonate) is an alternative source of calcium which may be effectively applied if the soil is acidic.

Both gypsum and lime contain calcium and they both also contribute electrolyte (salt) to the soil solution. Consequently, both products may have a role in improving sodic soils. Pure gypsum contains approx. 23% calcium and is moderately soluble. Pure lime (CaCO3) contains about 40% calcium but is much less soluble than gypsum and is essentially insoluble if the soil pH is above about 6.0 when measured in calcium chloride. Providing the pH is suitable, a mixture of gypsum and lime may be used, with the gypsum providing a quick response whilst the lime, with its lower solubility but higher calcium content, providing a longer-term benefit. The longer term benefit may be useful where it is anticipated that multiple doses of insect active agent are to be ablied over the course of months, or even annually.

Where soil pH greater than 6 gypsum alone may be used. For pH less than 6 but greater than about 5.4 a mixture of about 75:25 gypsum to lime may be used. For pH greater than 4.8 but less than about 5.4 a mixture of about 50:50 gypsum to lime may be used. For pH less than 4.8 lime alone may be used.

The skilled person is well aware of a number of test methods for determining the permeability of a soil, such tests being useful in determining whether or not an agent is capable of modifying soil permeability.

Due to the existence of the inter-connected voids, soils are permeable to at least some extent although not necessarily to the extent required to allow for the useful penetration of insect active agent into the soil. More permeable soils will allow the flow of aqueous fluids from points of high energy to points of low energy.

Permeability is the parameter to characterize the ability of soil to transport an aqueous fluid. One useful test for testing permeability is the constant-head permeability test method. In this test, water is forced by a known constant pressure through a soil specimen of known dimensions and the rate of flow is determined. The specimen consists of a representative portion of the sample under consideration from which all aggregate retained on a 19-mm sieve has been removed. No compensation is made for the plus 19 mm aggregate which has been removed.

1000 g of material is used for a moisture content determination of the air-dried material.

5000 g of air-dried material is used for the permeability test if the sample contains more than 10% retained on the 4.75 mm sieve, 4000 g of air-dried material is used for the permeability test if the sample contains 10% or less retained on the 4.75 mm sieve. The height of compacted specimen should be between 110 mm and 140 mm and it may be necessary to vary the amount depending on the grading and type of material.

Several specimens of 2500 g each, are used for determination of maximum impact test density.

Test specimens are compacted by adding water to bring the test specimen to slightly below the apparent optimum moisture content, or sufficient water to assure good compaction. The water and material are mixed thoroughly with the aid of a soil mixer.

The wetted specimen is compacted in the mold with solid base plate attached, in five equal layers, using a 45.4 kg hammer with a free fall of 457 mm.

Each layer receives 25 blows, or some other predetermined number of blows. Each compacted layer is scarified before adding the next layer.

After the fifth layer is compacted, the leveling piston on the specimen is set and five blows applied with the drop hammer. The mold is inverted, and the compacted specimen, and piston replaced with the base ring and 150 μm mesh sieve. The specimen is set upright, and the leveling piston removed. The height of the specimen (L) is determined to the nearest 1 mm.

At least three specimens are compacted, at different compaction efforts, in order to show a range in permeability with range in density.

The reservoir to the outlet level is filled with water. The perforated plate is placed on the specimen and the mold and specimen placed on the “U” shaped hanger to give a head of water of approximately 200 mm. It may be necessary to use less head if there is an exceptional high rate of flow, “K” of 60 or 90 m/day, (0.07-0.1 cm/sec) or if there is any indication of piping or of passing of fines from the sample during the test.

The percolation is allowed for some time to ensure a high degree of saturation and uniformity of test results.

Water is allowed to run into the intake reservoir at a rate slightly faster than the rate of flow through the specimen. The outlet reservoir is full to the point of overflow before the test is begun. The excess water from the outlet reservoir during the test is the amount that has flowed through the specimen.

The quantity of flow (Q) is determined by means of either a graduated container or by weighing, and determine the elapsed time (t) for the quantity of flow. These determinations are recorded.

Several test runs are made and the results averaged. If the first reading gives a much higher permeability than the second or third readings, the first reading is disregarded. The second and third readings are typically in close agreement.

The temperature of the water in degrees Celsius (° C.) is recorded, as is the head of water (H) and height of sample (L).

The permeability “K”, is calculated from the following formula:

K=Q/iAt
Q=quantity of water discharged
i=the hydraulic gradient=H/L
   where: H=head of water
      L=height of sample
A=cross-sectional area of specimen
t=elapsed time

the coefficient of permeability, K, to that for 20° C., is found by using the appropriate correction factor.

Another soil permeability test is the falling head permeability test method. In this test, water is forced, by a falling head pressure, through a soil specimen of known dimensions and the rate of flow is determined. This test is used to determine the drainage characteristics of relatively fine-grained soils and is usually performed on undisturbed samples.

Soil is extruded from the sample tube into the consolidometer rings (sampler tubing) by pushing the piston into the sample tube. This extrusion should move the sample in the same direction with reference to the tube as it moved during the sampling operation in order to minimize disturbance of the soil structure.

Specimens are trimmed to the exact height of the ring by means of a fine wire saw as shown

The soil ring is placed with specimen with “O” ring, on bottom porous stone. The consolidometer is slid over soil ring, upper plate placed and fastened securely to the base to ensure “O” ring seal.

top porous stone is inserted along with piston to apply a 6.0 kPa pressure on the specimen. Initial dial reading is recorded to determine subsequent change in specimen height, for unit weight calculations, due to increasing load increments.

Air is bled out of the system by allowing water to flow from the reservoir across the bottom porous stone and also through the conduit system.

Initial dial reading is recorded, then the load applied. Final dial reading is recorded.

The standpipe is filled and the height of water in the tube is recorded.

The quick-acting flow valve is release to commence the test.

Time (in seconds) is recorded for head of water to fall to the level of the overflow pipe.

The coefficient of permeability is calculated from the following formula:

K=2.3(aL/At)log 10(h1/h2)

Where:
K=coefficient of permeability.
a=cross-sectional area of the standpipe.
L=average height of the sample for the load increment.
A=cross-sectional area of the sample.
t=elapsed time increment.
h1=height of water at the beginning of time increment in millimeters.
h2=height of water at the end of time increment in millimeters

By such testing, and potential soil permeability modifying agent may be assessed for efficacy with any given soil sample.

In some embodiments, the soil permeability modifying agent is provided for use in the method in liquid form, typically as an aqueous solution, mixture, suspension or a slurry.

The soil permeability modifying agent may be capable of improving the permeability of soil to the insect active agent by at least about 1%, 5%, 10%, 15%, 20%, 25%, 30%, 35%, 40%, 45%, 50%, 75%, 100%, 125%, 150%, 175%, 200%, 225%, 250%, 300%, 400%, 500%, 750% or 1000%.

The skilled person understands that the dosage of soil permeability modifying agent may need to be adjusted to provide a desired improvement. For example, where the agent is used as an aqueous solution the concentration of the active agent may need to be increased or decreased in order to achieve a desired improvement. For example, where the soil permeability modifying agent is gyspurn, a saturated solution (about 2.0 to 2.5 g/l at 25 degrees) may be used, The skilled person understands that gypsum exhibits a retrograde solubility, becoming less soluble at higher temperatures and so may adjust any concentrations according to temperature.

If a higher dosage is required, a suspension or slurry may be made whereby a proportion of the gypsum is not in solution. In those circumstances, the suspension or slurry is delivered to the soil and whereby the gypsum not in solution dissolves by contact with water in the soil or by the water present in a solution of insect active agent that is co-contacted with the soil, or contacted after contacting with the soil permeability modifying agent.

The soil permeability modifying agent may be allowed to contact the soil (either alone, or with the insect active agent) for a period of time in order to ensure that exposure of a sufficient soil region with insect active agent is achieved. The contact time in some embodiments is at least about 1 minute, 5 minutes, 10 minutes, 15 minutes, 30 minutes, 45 minutes, 60 minutes, 2 hours, 3 hours, 4 hours, 5 hours, 6 hours, 7 hours, 8 hours, 9 hours, 10 hours, 11 hours, 12 hours, 18 hours, 24 hours, 2 days, 3 days, 4 days or 5 days.

The delivery means, any reservoir, any connecting means or other hardware are preferably configured form part of a permanent installation. In this way, the soil about a building may be dosed at regular intervals, or even continuously to achieve superior protection from invading insects. Accordingly, any or all of the aforementioned components may be fabricated from weather resistant and/or UV stabilised plastics. Similarly, corrosion-resistant metal components may be incorporated where necessary for longevity.

It will be apparent that the present methods, in some embodiments, do not require a soil removal step. Soil removal is a significant problem with “trenching” approaches to the delivery of insecticides in termite control. In embodiments of the present methods where the removal of soil is required, the amount of soil removed may be less than that required in prior methods such as trenching.

In a second aspect there is provided a system for contacting the soil about a building with one or more active agents, the system comprising:
fluid delivery means configured to dispense an insect active agent and a soil permeability modifying agent to a zone of soil,
an insect active agent, and
a soil permeability modifying agent.

Any and all of the features described supra with reference to the inventive methods may be features of the present systems, and are preferred or optional features of the present systems. For the sake of clarity and brevity, the features will not be reiterated at this point in the specification but are nevertheless incorporated herewith.

It is contemplated that the present systems can be retrofitted to existing buildings and arrangements of structures, or indeed incorporated into the construction of a building. Fitting of components of the present systems will be facilitated by the provision of a kit of parts.

Accordingly, a third aspect of the present invention provides a kit of parts for contacting the soil about a building with one or more active agents, the kit comprising
fluid delivery means configured to dispense an insect active agent and a soil permeability modifying agent to a zone of soil,
an insect active agent, and
a soil permeability modifying agent.

Any and all of the features described supra with reference to the inventive methods and systems may be features of the present kits, and are preferred or optional features of the present kits. For the sake of clarity and brevity, the features will not be reiterated at this point in the specification but are nevertheless incorporated herewith.

Optionally, the kit is comprised in packaging to form a vendible product. The kit may include instructions for use of the kit components, the instructions being embodied in any suitable form including text, video, audio, or graphical. The instructions may be printed directly onto any component of the kit, or any associated packaging. Instructions may be presented on a discrete pamphlet, user manual, online presentation system, in electronic form (such as portable document format, text file, or DVD).

The invention may be said broadly to consist in the parts, elements and features referred to or indicated in the specification of the application, individually or collectively, in any or all combinations of two or more of said parts, elements or features. Wherein the foregoing description reference has been made to integers or components having known equivalents thereof, those integers are herein incorporated as if individually set forth.

The present invention will now be more fully described by reference to preferred embodiments.

### DETAILED DESCRIPTION OF PREFERRED EMBODIMENTS

Apparatus for Application of Soil Permeability Modifying Agent and Insect Active Agent to Soil about a Building.

FIGS. 1 to 3 show preferred embodiments for delivering an insect active agent about a building, all having in common an external wall of the building 10, a frame of the building 12, and an interior wall of the building 14, the external wall 10 and frame 12 being supported by a concrete foundation 17. Surrounding the building is soil 18.

FIG. 1A is an embodiment applicable to a building having a concrete abutment 16 disposed on top of the soil 18. The abutment 16 forms a gap 19 with the external wall 10 of the building. The gap 19 runs about the perimeter of the building.

It will be noted that the gap 19 is continuous with the soil 18 and the upper surface of the abutment 16. A beveled edge 24 has been cut into the abutment 16, allowing for the disposition of a pipe 20 in the recess so formed. The pipe 20 runs about the perimeter of the building. A protective trim 26 is disposed above the pipe 20. The pipe 20 has a plurality of perforations 22 (one shown) disposed downwardly and toward the gap 19.

In operation liquid soil permeability modifying agent and the liquid insect active agent is run through the pipe 20, the agents exiting via the perforations 22 and flowing into the gap 19 and subsequently into the soil 18.

FIG. 1B is the embodiment of FIG. 1A and showing the contact zone 40 within the soil 18, the contact zone 40 being that soil contacted by the soil permeability modifying agent and the insect active agent.

FIG. 2A is an embodiment having a concrete abutment 16 disposed on top of the soil 18. A plurality of bore holes 28 are drilled into the abutment 16, or have previously been drilled in the course of a previous rod injection treatment about the perimeter of the building. A single bore hole 28 is shown.

A shallow trench 30 is cut into the abutment 16, the trench connecting each of the plurality of bore holes allowing for the disposition of a pipe 20 in the recess so formed. A trench cover 32 is disposed over the pipe 20.

The pipe 20 has a plurality of perforations 22 (one shown) disposed downwardly and toward the bore holes 28.

In operation the soil permeability modifying agent and the liquid insect active agent is run through the pipe 20, the agents exiting via the perforations 22 and flowing into the bore holes 28 and subsequently into the soil 18.

FIG. 2B is the embodiment of FIG. 2A and showing the contact zone 40 within the soil 18, the contact zone 40 being that soil contacted by the soil permeability modifying agent and the insect active agent.

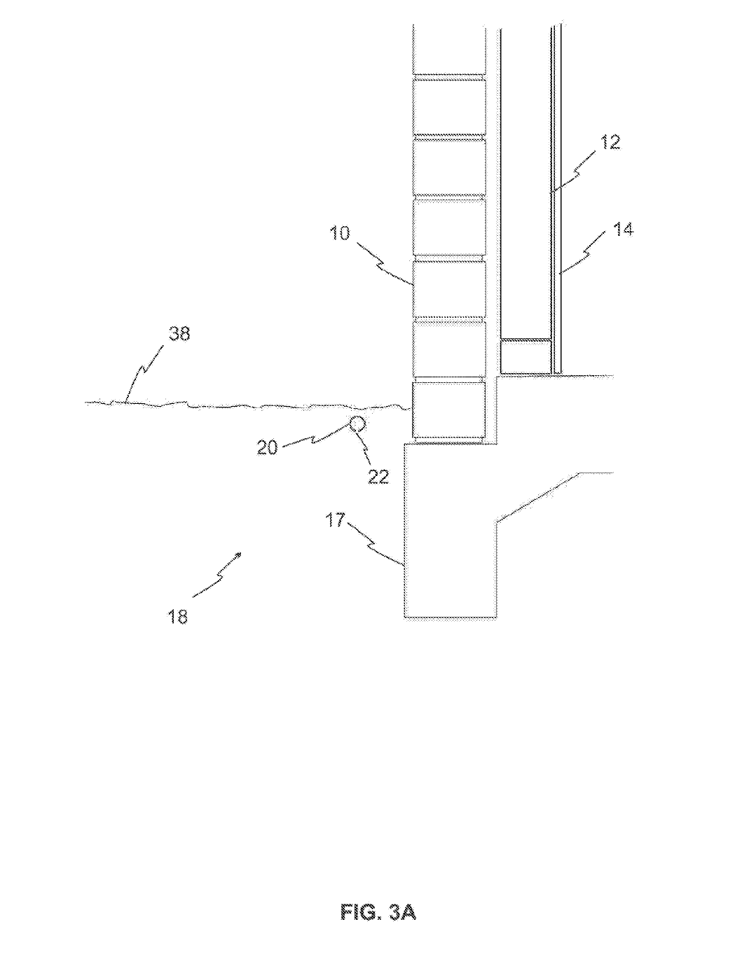

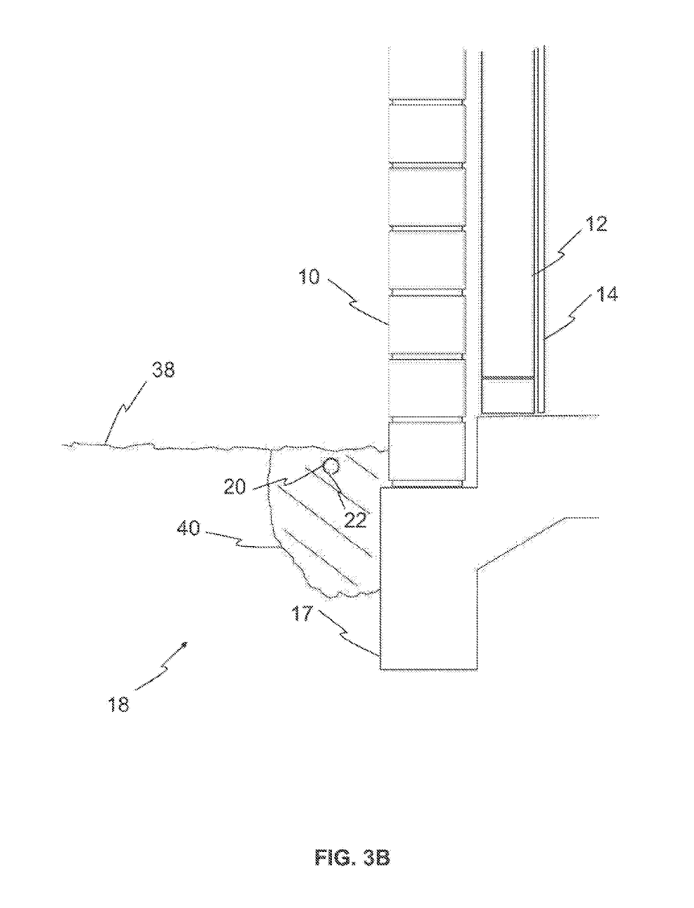

FIG. 3A is an embodiment where there is no abutment against the budding. Instead, the soil surface 38 directly contacts the external wall 10 of the building. The pipe 20 is buried in the soil 18 and proximal to the external wall 10. The soil permeability modifying agent and the insect active agent exits the pipe 20 via the plurality of perforations 22 (one shown).

FIG. 3B is the embodiment of FIG. 3A and showing the contact zone 40 within the soil 18, the contact zone 40 being that soil contacted by the soil permeability modifying agent and the insect active agent.

Method for application of soil permeability modifying agent and insect active agent to soil about a building.

A saturation solution of gypsum is prepared in water loaded into a reservoir configured to attach to the pipe 22 of the apparatus of FIGS. 1A and 1B as described supra. The gypsum solution is allowed to run under gravity and the exit the perforations 22 to contact the soil 18. As the soil 18 becomes more permeable, further gypsum solution flows into the soil. The flow rate of the gypsum solution is a useful indicator of how long the soil should be pre-treated. Typically, the flow rate is slow but then increases as the soil permeability increases.

The penetration may be enhanced by injecting the gypsum solution into the soil under pressure (not shown). For example, the system (including the reservoir) may be substantially closed and a pressurized gas injected into the reservoir to force the gypsum solution out of the perforations 22.

Once the soil has been contacted with sufficient gypsum solution to provide an acceptable level of soil permeability, the reservoir is filled with an insect agent. Given the improved soil permeability (caused by the application of the gypsum solution) the insect active agent is able to penetrate more fully into the soil so as to allow for the establishment of a continuous zone of insect active agent about the building.

The degree of soil permeability required to establish a continuous zone of insecticide about a building can be determined by performing testing on the soil. As will be understood, a permeability is required such that insecticide introduced at one bore hole penetrates into the soil such that it meets with insecticide introduced into an adjacent bore hole. Given the benefit of the present specification the skilled person is enabled by routine means only to test soil, select an appropriate permeability modifying agent (and conditions for contacting the agent to the soil) in order to achieve a continuous zone of protection about a building. It will be appreciated, however, that in some circumstances characteristics of the soil do not permit the established of a continuous zone of protection. However, a continuous protection is available for at least some soil types.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art.

It will be appreciated that in the detailed description and thee description of preferred embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment Thus, the following claims are hereby expressly incorporated into this description, with each claim standing on its own as a separate embodiment of this invention.

Furthermore, while some embodiments described herein include some but not other features included in other embodiments, combinations of features of different embodiments are meant to be within the scope of the invention, and from different embodiments, as would be understood by those in the art. For example, in the claims appended to this description, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

1. A method for contacting the soil about a building with one or more insect active agents, the method comprising acts of:
providing an insect active agent,
providing a soil permeability modifying agent,
contacting the soil with the soil permeability modifying agent to provide a modified soil, and
contacting the modified soil with the insect active agent,
wherein the soil permeability modifying agent improves the soil permeability to facilitate penetration of the insect active agent into the soil.

2. The method of claim 1 wherein the soil is contacted with the soil permeability modifying agent before contacting the soil with the insect active agent.

3. The method of claim 1 wherein the soil permeability modifying agent increases permeability of the soil.

4. The method of claim 1 wherein the soil permeability modifying agent is capable of increasing the permeability of clay soil and/or a sodic soil.

5. The method of claim 1 wherein the soil permeability modifying agent acts by at least one of an electrolyte effect, an ion exchange effect, a wetting effect, a soil pore stabilizing effect, a detergent effect, a penetrant effect, a flocculent effect, and/or by an emulsifying effect, a soil stabilizing effect.

6. The method of claim 1 wherein the soil permeability modifying agent comprises at least one of gypsum or lime.

7. The method of claim 1 wherein the insect active agent is active against a termite species.

8. The method of claim 1 wherein where the building has an abutting structure, the insect active agent and soil permeability modifying agent are contacted with the soil via a channel disposed between the external wall of the building and the abutting structure.

9. The method of claim 8 wherein the channel is an abutment gap included in the construction of the building and/or abutting structure.

10. The method of claim 1 wherein where the building has an abutting structure, the insect active agent and soil permeability modifying agent are contacted with the soil via a plurality of bore holes disposed in the abutting structure.

11. The method of claim 10 wherein the plurality of bore holes are disposed proximal to the external wall of the building.

12. The method of claim 11 wherein the existing bore holes are bore holes that were created primarily or exclusively for the rod injection of an insect active agent into the soil beneath the abutting structure.

13. The method of claim 1 wherein a substantially continuous zone of insect active agent is provided about the perimeter of the building.

14. The method of claim 1 that does not require excavation of the soil about the building.

15. A system for contacting the soil about a building with one or more active agents, the system comprising:
fluid delivery means configured to dispense an insect active agent and a soil permeability modifying agent to a zone of soil,
an insect active agent, and
a soil permeability modifying agent.
